(19) United States
(12) Patent Application Publication
(10) Pub. No.: US 2016/0350566 A1
(43) Pub. Date: Dec. 1, 2016

(54) ARRANGEMENT FOR AND METHOD OF ELECTRO-OPTICALLY READING TARGETS OF DIFFERENT TYPES BY IMAGE CAPTURE

(71) Applicant: SYMBOL TECHNOLOGIES, LLC, LINCOLNSHIRE, IL (US)

(72) Inventors: DAVID C. YE, BALDWIN, NY (US); WANLI CHI, STONY BROOK, NY (US); CHINH TAN, SETAUKET, NY (US)

(21) Appl. No.: 14/723,973

(22) Filed: May 28, 2015

(51) Int. Cl. G06K 7/10

(52) U.S. Cl. CPC G06K 7/10732; G06K 7/10752

(57) ABSTRACT

Different types of targets are illuminated by first and second illuminating assemblies. A solid-state imager is exposed during a first exposure period, and not exposed during a first non-exposed period, during a first frame. The first illuminating assembly produces a first light pulse during the first exposure period to capture return light from a first target type. The imager is exposed during a second exposure period, and not exposed during a second non-exposed period, during a second frame. The second light assembly produces a second light pulse during the second exposure period to capture return light from a second target type. During the non-exposed periods, a plurality of light pulses are produced with a combined illumination light output power that is substantially the same for each frame and at an illumination rate that enables a human eye to perceive the illumination light pulses as substantially continuous in illumination.

### BACKGROUND OF THE INVENTION

The present disclosure relates generally to an arrangement for, and a method of, electro-optically reading targets of different types, especially direct part marking (DPM) targets, such as either sunken or raised optical codes on either generally planar or curved workpieces having either reflective or matte surfaces, by image capture.

Solid-state imaging systems or imaging readers have been used in many industries, in both handheld and/or hands-free modes of operation, to image various targets, such as printed symbol targets, e.g., bar code symbols to be electro-optically decoded and read, particularly one-dimensional bar code symbols, such as the Universal Product Code (UPC) symbology having a row of bars and spaces spaced apart along a linear direction, as well as two-dimensional symbols, such as the Code 49 symbology having a plurality of vertically stacked rows of bar and space patterns in a single symbol; non-symbol targets, such as documents, drivers' licenses, prescriptions, etc., to be imaged and processed for storage or display; and direct part marking (DPM) targets, e.g., machine-readable, high-density, one- or two-dimensional, optical codes, such as DataMatrix or QR codes, each DPM code being comprised of multiple elements that are directly marked (imprinted, etched, molded, or dot-peened) on a metal, plastic, leather, or glass, etc., workpiece. For example, an outer surface of a DPM-marked, metal workpiece may advantageously be dot-peened with sunken elements as hemispherical depressions; an outer surface of a plastic workpiece may advantageously be molded with raised elements as hemispherical bumps; and a laser may be used to etch elements of different light reflectivity closely adjacent an outer surface of a workpiece. Other shapes for the elements, and other DPM marking techniques, may also be used.

A known imaging reader includes a housing either held by an operator and/or supported on a support surface, a window supported by the housing and aimed at the target during imaging, and an imaging engine or module supported by the housing. The imaging module includes an exposable, solid-state imager, e.g., a one- or two-dimensional charge coupled device (CCD) or a complementary metal oxide semiconductor (CMOS) device and associated circuits for producing and processing electrical signals. The imager has a sensor array of photocells or light sensors that correspond to image elements or pixels over a field of view of the imager, an energizable illuminating light assembly for illuminating the target, typically with pulsed illumination light, and an imaging lens assembly for capturing return light scattered and/or reflected from the illuminated target, and for projecting the captured return light onto the sensor array to capture an image of the illuminated target during an exposure time period. The electrical signals are processed by a programmed microprocessor or controller into data indicative of the target being decoded and read, or into a picture of the target.

Although the known imaging readers are satisfactory for reading printed symbol and non-symbol targets, the use of imaging readers for reading DPM targets, especially of different types, on workpieces has proven to be challenging. Each DPM target is relatively small, e.g., less than 2 mm×2 mm. The workpieces themselves may often have complicated, i.e., non-planar, curved, reflective surfaces. Contrast between the DPM targets and their workpiece backgrounds, especially from outer, reflective background surfaces, is often less than desirable. Unlike symbol targets printed in one color (for example, black) on paper of another color (for example, white), DPM targets are typically read not by a difference in intensity of the return light between regions of different color, but by shadow patterns that are cast by the raised or sunken or etched elements.

In order to more readily read DPM targets of such different types, e.g., either sunken or raised elements provided on either generally planar or curved workpieces having either reflective or matte surfaces, the art has proposed adding optical elements, such as diffusers and optical filters to the illuminating light assembly, and adjusting the illuminating light assembly until the DPM target is well and uniformly lit. However, this is not only labor-intensive, costly and adds excess weight, but also is good for reading only one type of DPM target since another type of DPM target would require a separate lighting adjustment. The art has also proposed the use of more than one illuminating light assembly with different illumination light output powers to illuminate the DPM code, and using software that performs statistical analysis to determine which illuminating light assembly to energize. This allows different types of DPM targets to be read. However, switching between the illuminating light assemblies creates a “blinking” effect. Bright illumination pulses shining out of the window as flashes of light at different illumination light output powers, especially at low pulse rates below 20 pulses per second, can be annoying or uncomfortable to the operator, or to a consumer standing nearby the reader.

Accordingly, there is a need to enhance the readability of targets, especially DPM targets, of different types to be read by image capture in a more cost-efficient and rapid manner without resorting to extra hardware that increases cost and weight, without resorting to special labor-intensive lighting adjustment procedures, and without resorting to extra software that slows reading performance, while reducing, if not eliminating, any blinking or light flashing effect caused by switching between illuminating assemblies.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of an exemplary imaging reader for electro-optically reading targets of different types by image capture in accordance with this disclosure.

FIG. 2 is a front elevational view on a reduced scale of the reader of FIG. 1.

FIG. 3 is a diagrammatic, simplified view of a reader analogous to that shown in FIGS. 1-2, depicting various components thereof.

FIG. 4 is an enlarged, front elevational view looking into a window of the reader of FIGS. 1-2 and depicting a pair of illuminating light assemblies.

FIG. 5 is a perspective view of the illuminating light assemblies of FIG. 4 in isolation.

FIG. 6 is an enlarged, sectional view of an exemplary DPM target of one type to be read.

FIG. 7 is an enlarged, plan view of the DPM target of FIG. 6.

FIG. 8 is an enlarged view of an exemplary DPM target of a different type to be read.

FIG. 9 is a graph depicting frame, exposure and illumination rates of various components of the reader of FIGS. 1-2.

FIG. 10 is a flow chart depicting a method of reading targets of different types by image capture in accordance with this disclosure.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The arrangement and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

An arrangement, in accordance with one feature of this disclosure, is operative for electro-optically reading different types of targets by image capture. Such targets may include direct part marking (DPM) codes on a workpiece whose outer surface is either reflective or matte, or generally planar or curved. The DPM codes comprise elements that may either be raised and/or sunken relative to the outer surface. Other types of targets include printed bar code symbols and non-symbol targets, such as documents.

The arrangement includes a housing, preferably having at least one light-transmissive window. The housing is preferably configured as a handheld, portable scanner, but could also be configured as a stand-mounted scanner, a vertical slot scanner, a flat-bed or horizontal slot scanner, or a bi-optical, dual window scanner. The arrangement includes an imaging module supported by the housing and including first and second, energizable, illuminating light assemblies for illuminating the different types of targets through the window; an imaging assembly including a solid-state imager exposable during successive frames; and a controller or programmed microprocessor for controlling the illuminating light assemblies and the imaging assembly.

The controller exposes the imager during a first exposure time period, and does not expose the imager during a first non-exposed time period, during one of the frames. The controller energizes the first illuminating light assembly to produce a first illumination light pulse during the first exposure time period to capture return light through the window from a first type of target illuminated by the first illumination light pulse. The controller also exposes the imager during a second exposure time period, and does not expose the imager during a second non-exposed time period, during another of the frames. The controller energizes the second illuminating light assembly to produce a second illumination light pulse during the second exposure time period to capture return light through the window from a second type of target illuminated by the second illumination light pulse. Thus, one type of target is illuminated by one of the illuminating light assemblies and attempted to be read during the one frame, while another type of target is illuminated by another of the illuminating light assemblies and attempted to be read during the other frame, thereby insuring that each type of target will be properly illuminated and read during at least one of the frames.

The controller further energizes the first and/or second illuminating light assembly to produce another first and/or second illumination light pulse during the first non-exposed time period, and energizes the first and/or second illuminating light assembly to produce another first and/or second illumination light pulse during the second non-exposed time period, to produce a plurality of the first and second illumination light pulses having a combined illumination light output power that is substantially the same for each frame and at an illumination rate that enables a human eye to perceive the first and second illumination light pulses as substantially continuous in illumination from frame to frame due to persistence of vision on the human retina. The output light power of all the illumination light pulses in each frame is substantially the same. Thus, the aforementioned annoying blinking and light flashing effect is reduced, if not eliminated.

In accordance with another feature of this disclosure, a method of electro-optically reading different types of targets by image capture is performed by illuminating the different types of targets with first and second, energizable, illuminating light assemblies; by operating a solid-state imager during successive frames; by exposing the imager during a first exposure time period, and not exposing the imager during a first non-exposed time period, during one of the frames; by energizing the first illuminating light assembly to produce a first illumination light pulse during the first exposure time period to capture return light from a first type of target illuminated by the first illumination light pulse; by exposing the imager during a second exposure time period, and not exposing the imager during a second non-exposed time period, during another of the frames; by energizing the second illuminating light assembly to produce a second illumination light pulse during the second exposure time period to capture return light from a second type of target illuminated by the second illumination light pulse; by energizing the second illuminating light assembly to produce another second illumination light pulse during the first non-exposed time period; and by energizing the first illuminating light assembly to produce another first illumination light pulse during the second non-exposed time period, to produce a plurality of the first and second illumination light pulses having a combined illumination light output power that is substantially the same for each frame and at an illumination rate that enables a human eye to perceive the first and second illumination light pulses as substantially continuous in illumination from frame to frame.

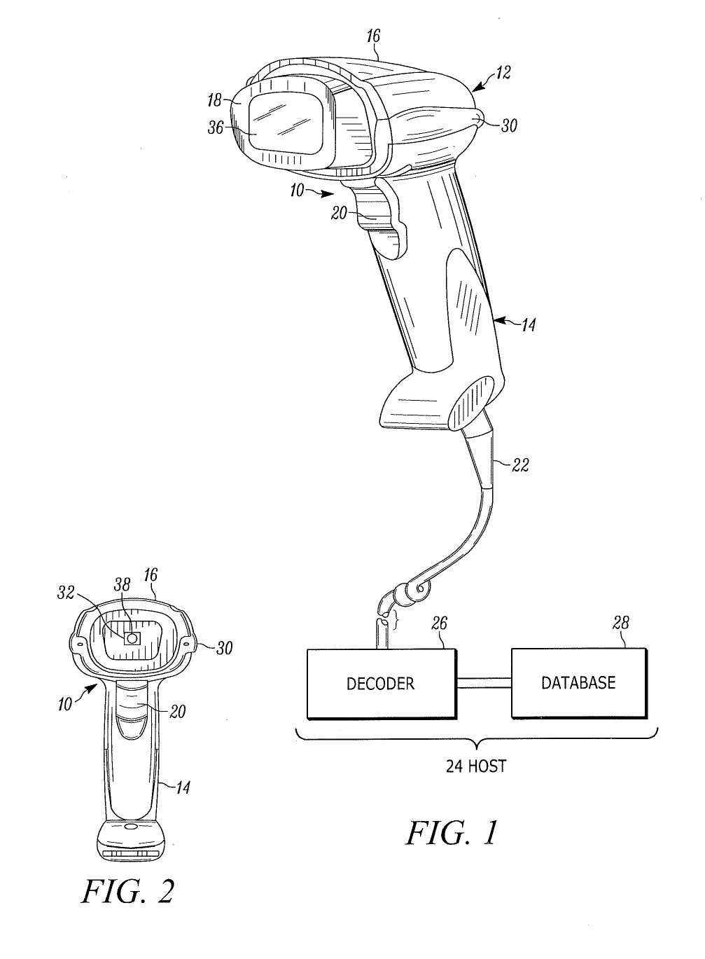

Reference numeral 10 in FIGS. 1-2 generally identifies an exemplary, handheld, portable imaging reader for electro-optically reading different types of targets, such as a printed bar code symbol, a document, or a DPM code 100 (see FIGS. 6-8) on a workpiece 200, which can either be generally planar (FIG. 6) or curved (FIG. 8). As described below, the DPM code 100 has elements 102 on an outer target surface 104 of the workpiece 200, and the outer target surface 104 can either be matte (FIG. 6) or reflective (FIG. 8). The reader 10 includes a housing 12 in which an imaging module, as described below, is supported. The housing 12 includes a generally elongated handle or lower handgrip portion 14 and a barrel or upper body portion 16 having a front end region 18. A light-transmissive window 36 is supported at the front end region 18. The cross-sectional dimensions and overall size of the handle 14 are such that the reader 10 can conveniently be held in an operator's hand. The body and handle portions may be constructed of a lightweight, resilient, shock-resistant, self-supporting material, such as a synthetic plastic material. The plastic housing 12 may be injection molded, but can be vacuum-formed or blow-molded to form a thin hollow shell which bounds an interior space whose volume is sufficient to contain the imaging module. An overmold 30 of a resilient, shock-absorbing material, such as rubber, is exteriorly molded at various regions over the housing 12 for shock protection.

A manually actuatable trigger 20 is mounted in a moving relationship on the handle 14 in a forward facing region of the reader. The operator's forefinger is normally used to actuate the reader to initiate image capture and reading by depressing the trigger 20. A flexible electrical cable 22 may be provided to connect the reader 10 to a remote host 24. In alternative embodiments, the cable 22 may also provide electrical power to the electrical components within the reader. In preferred embodiments, the cable 22 is connected to the remote host 24 that receives decoded data from the reader 10. In alternative embodiments, a decoder 26 may be provided exteriorly to the reader. In such an embodiment, decoded data from the decoder 26 may be transmitted to further host processing equipment and databases represented generally by box 28. If the cable 22 is not used, then a wireless link to transfer data may be provided between the reader 10 and the host 24, and an on-board battery, typically within the handle 14, can be used to supply electrical power.

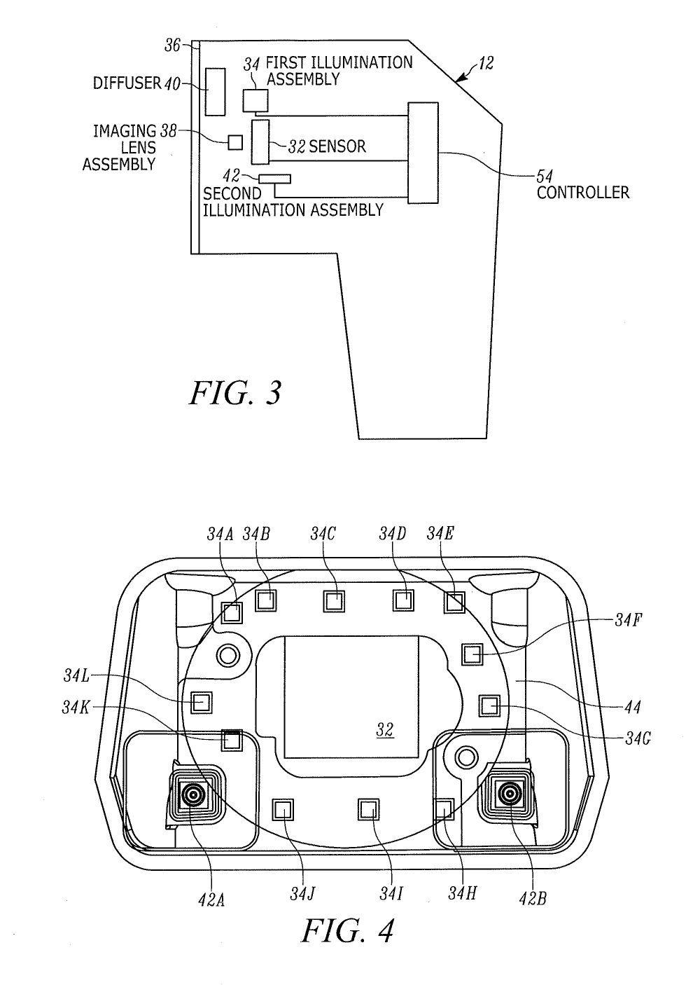

The imaging module contains a solid-state imager 32, as diagrammatically shown in FIG. 3, that is mounted within the housing 12. The imager 32 is a one- or two-dimensional charge coupled device (CCD) or a complementary metal oxide semiconductor (CMOS) device, and has a sensor array of photocells or light sensors that correspond to image elements or pixels over a field of view of the imager, together with associated circuits for producing and processing electrical signals. An imaging lens assembly 38, e.g., a fixed focus, Cooke triplet, captures return light scattered and/or reflected from the target through the window 36, and projects the captured return light onto the sensor array to capture an image of the target. The electrical signals are processed by a programmed microprocessor or controller 54 into data indicative of the target being decoded and read, or into a picture of the target.

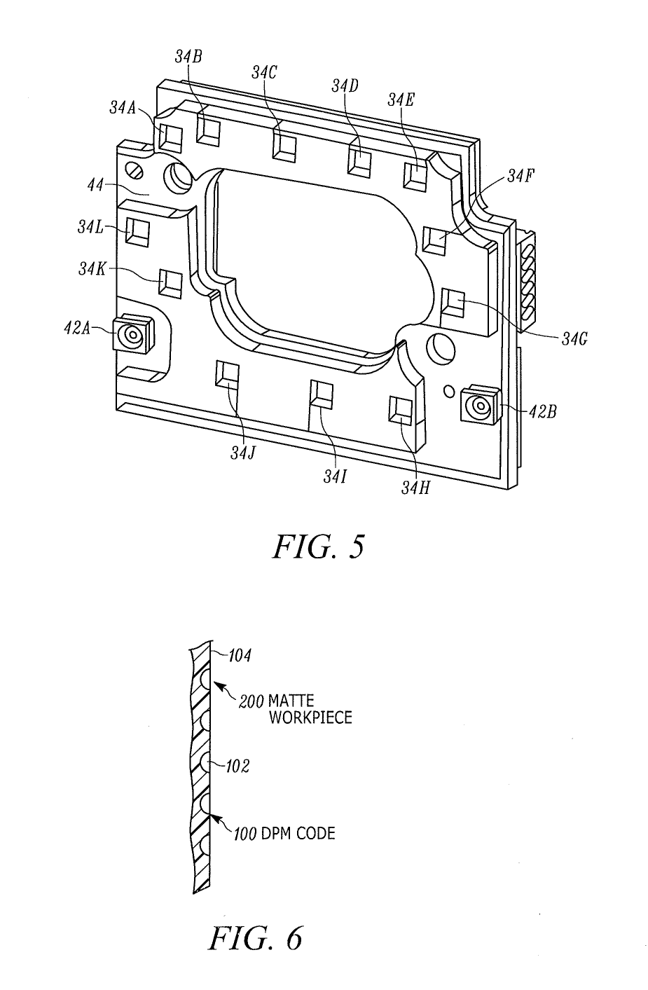

The imaging module further contains a first energizable, illuminating light assembly 34 and a second energizable, illuminating light assembly 42 for illuminating the different types of targets through the window 36, typically with pulsed illumination light. Each illuminating light assembly 34, 42 includes at least one illumination light source, and preferably a plurality of illumination light sources, e.g., light emitting diodes (LEDs), energized by the controller 54. As best shown in FIGS. 4-5, the first illuminating light assembly 34 includes a ring of LEDs 34A, 34B, 34C, 34D, 34E, 34F, 34G, 34H, 34I, 34J, 34K, 34L generally arranged in an annulus around the imager 32 and mounted on a printed circuit board 44. The LEDs 34A-34L generate illumination light, each at a relatively low output power level, e.g., 0.1 w. A diffuser 40 is operative for diffusing the illumination light from the first illuminating light assembly 34 en route to the target. The diffuser 40 minimizes hot spots, glare and specular reflections and renders the illumination light from the first illuminating light assembly 34 more uniform across the target. The diffuser 40, preferably a translucent or textured member, scatters the illumination light emitted by the first illuminating light assembly 34 and is best suited for illuminating targets on reflective or curved workpieces.

As also best shown in FIGS. 4-5, the second illuminating light assembly 42 includes at least one LED, and preferably a pair of LEDs 42A, 42B, mounted on the board 44 adjacent the imager 32. The LEDs 42A, 42B generate illumination light, each at a relatively high output power level, e.g., 0.3 w, and is best suited for illuminating targets on matte or generally planar workpieces, as well as printed bar code symbols and documents.

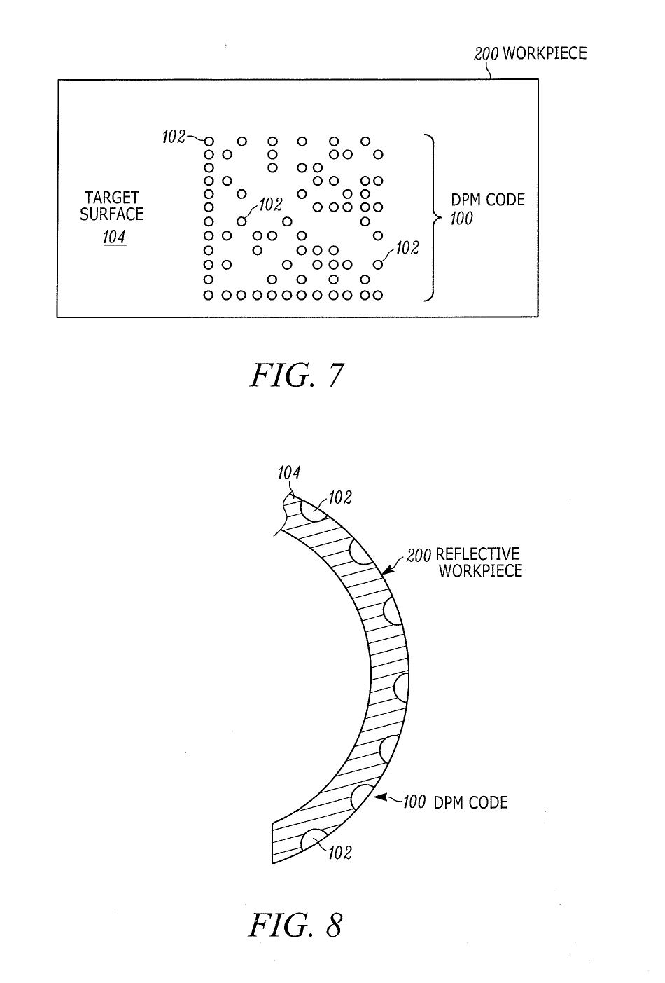

Returning to FIGS. 6-8, the DPM code 100 is comprised of multiple elements 102 that are directly marked (imprinted, etched, molded, or dot-peened) on the workpiece 200. For example, an outer target surface 104 of a metal workpiece 200 may advantageously be dot-peened with sunken elements 102 as hemispherical depressions that are located below, or behind, the target surface 104; or the outer target surface 104 of a plastic workpiece 200 may advantageously be molded with raised elements 102 as hemispherical bumps that are located above, or in front of, the target surface 104; or the outer target surface 104 of any workpiece 200 may advantageously be etched with, for example, a laser, to form elements 102 of different light reflectivity closely adjacent the outer target surface 104 of the workpiece 200. Shapes, other than the circular shapes illustrated in FIGS. 6-8, for the elements 102, and marking techniques, other than laser-etching, are also contemplated by this disclosure. Although illustrated in FIG. 7 as being arranged in a two-dimensional matrix-type array, the elements 102 can also be linearly arranged as a character string.

In operation, in response to actuation by the trigger 20, the controller 54 sends a command signal for energizing the imager 32 to capture the return light at a frame rate, e.g., about 30-60 frames per second, and at a corresponding exposure rate, and a separate command signal for independently energizing each illuminating light assembly 34, 42 to produce illumination light pulses at an illumination rate. The frame rate, or frame frequency, is the frequency at which the imager 32 produces unique consecutive target images called frames. The illumination rate, or illumination frequency, is the frequency at which the illumination light pulses are generated by each illuminating light assembly 34, 42.

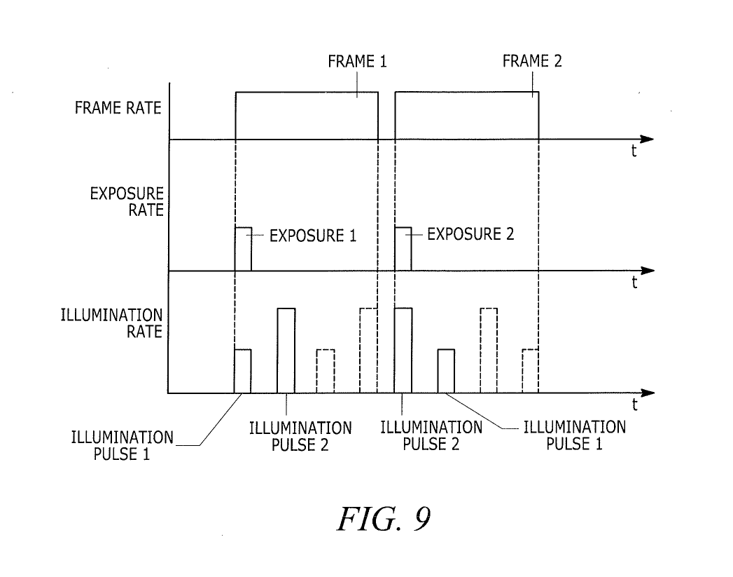

The graph of FIG. 9 depicts the frame rate as exemplified by two successive frames 1 and 2, the exposure rate as exemplified by two successive exposures 1 and 2, and the illumination rate as exemplified by the first illumination pulses 1 and the second illumination pulses 2. In accordance with this disclosure, the controller 54 exposes the imager 32 during a first exposure time period (exposure 1), and does not expose the imager 32 during a first non-exposed time period, during one of the frames, e.g., frame 1. By way of non-limiting numerical example, if frame 1 has a duration of about 16 msec, and if exposure 1 has a duration of about 1-4 msec, then the first non-exposed time period, i.e., the remaining time of frame 1, has a duration of about 12-15 msec. The controller 54 energizes the first illuminating light assembly 34 to produce a first illumination light pulse (illumination pulse 1) during the first exposure time period (exposure 1) to capture return light through the window 36 from a first type of target illuminated by the first illumination light pulse (illumination pulse 1).

The controller 54 also exposes the imager 32 during a second exposure time period (exposure 2), and does not expose the imager 32 during a second non-exposed time period, during another of the frames, i.e., frame 2. The second non-exposed time period is the remaining time of frame 2. The controller 54 energizes the second illuminating light assembly 42 to produce a second illumination light pulse (illumination pulse 2) during the second exposure time period (exposure 2) to capture return light through the window 36 from a second type of target illuminated by the second illumination light pulse (illumination pulse 2). Thus, one type of target is illuminated by one of the illuminating light assemblies and attempted to be read during frame 1, while another type of target is illuminated by another of the illuminating light assemblies and attempted to be read during frame 2, thereby insuring that each type of target will be read during at least one of the frames. The frames 1 and 2 need not be consecutive as illustrated, but could be spaced apart by one or more frames.

It will be noted from FIG. 9 that the illumination pulse 1 in frame 1 has a lower amplitude or output power level than the illumination pulse 2 in frame 2. As noted above, the illumination pulse 1 is generated by the first illuminating light assembly 34, is diffused, and has a relatively low output power, thereby making the type of target best suited to be read in frame 1 to be a DPM-marked workpiece having a reflective or curved outer surface 104. The illumination pulse 2 generated by the second illuminating light assembly 42, is direct and not diffused, and has a relatively high output power, thereby making the type of target best suited to be read in frame 2 to be a DPM-marked workpiece having a matte or generally planar outer surface 104, or a bar code symbol, or a document.

The controller 54 further energizes the second illuminating light assembly 42 to produce another second illumination light pulse (illumination pulse 2) during the first non-exposed time period in frame 1, and energizes the first illuminating light assembly 34 to produce another first illumination light pulse (illumination pulse 1) during the second non-exposed time period in frame 2. The plurality of the first and second illumination light pulses is thus produced with a combined illumination light output power that is substantially the same for each frame and at an illumination rate that enables a human eye to perceive the first and second illumination light pulses as substantially continuous in illumination from frame to frame due to persistence of vision on a human retina. Thus, the aforementioned annoying blinking and light flashing effect is reduced, if not eliminated.

As shown in FIG. 9, the duration of all the illumination pulses are the same. The duration of the illumination pulses generated during the first and second, non-exposed time periods can be increased. In addition, additional illumination pulses can be generated during the first and second, non-exposed time periods. For example, during frame 1, additional illumination pulses 1 and 2, as exemplified by additional pulses in dashed lines, could be generated, and during frame 2, additional illumination pulses 2 and 1, as exemplified by dashed lines, could be generated. These additional illumination pulses increase the combined illumination light output power and the illumination rate to be sufficiently high so that all the first and second illumination light pulses tend to blend together and mask any flicker or light flashing effect between frame 1 and frame 2.

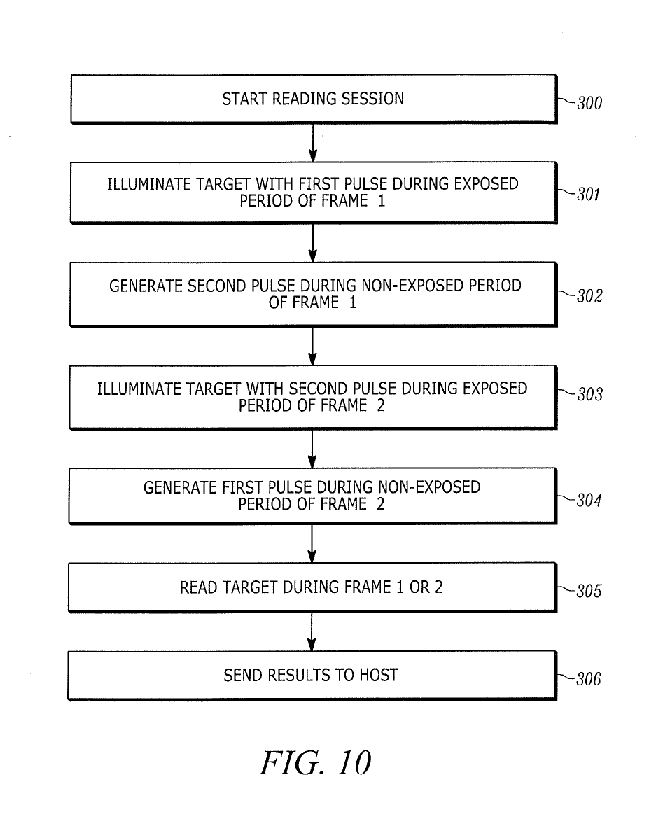

With the aid of the operational flow chart of FIG. 10, the method of this disclosure is performed beginning a reading session at start step 300 by illuminating a target with a first illumination pulse during the exposed time period of frame 1 (step 301), generating a second illumination pulse during the non-exposed time period of frame 1 (step 302), illuminating the target with a second illumination pulse during the exposed time period of frame 2 (step 303), generating a first illumination pulse during the non-exposed time period of frame 2 (step 304), reading the target during frame 1 or frame 2 (step 305), and sending the results to the host 24 (step 306). FIG. 10 is not shown in chronological order, for example, the reading of a target (step 305) could occur right after step 301 or step 303.

This disclosure is not intended to be restricted to reading DPM targets, because other raised/sunken/etched targets could also be read. For example, credit/debit cards have raised targets, e.g., a number and/or other data, elevated above its background surface. The background surface of the card is typically highly reflective and bears busy graphic patterns, all of which renders the contrast between the raised targets and the background card surface to be very low. Automatic optical character recognition (OCR) and reading is therefore problematic, and the above-described arrangement and method facilitates such OCR reading. As another example, a vehicle license plate has raised targets, e.g., alphanumeric characters and/or other data, elevated above its background plate surface. The background surface of the plate is typically highly reflective, and poor contrast between the raised targets and the background plate surface is aggravated by ever present dirt and mud on the plate surface, as well as damage to the plate. As still another example, seals impressed into a document could be read and verified in accordance with this disclosure.

This disclosure is also not intended to be restricted to only two illuminating light assemblies, since more than two illuminating light assemblies can be provided. For example, if a third illuminating light assembly is mounted in the imaging module, then, analogous to that described above, the third illuminating light assembly would generate a third illumination light pulse during an exposed time period of a third frame to capture return light through the window 36 from a third type of target illuminated by the third illumination light pulse. In addition, the third illuminating light assembly and/or the first and/or second illuminating light assembly could respectively generate the third illumination light pulse and/or the first and/or second illumination light pulse during the non-exposed time period of frame 1, and the third illuminating light assembly and/or the first and/or second illuminating light assembly could respectively generate the third illumination light pulse and the first and/or second illumination light pulse during the non-exposed time period of frame 2.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or arrangement that comprises, has, includes, contains a list of elements does not include only those elements, but may include other elements not expressly listed or inherent to such process, method, article, or arrangement. An element proceeded by “comprises . . . a,” “has . . . a,” “includes . . . a,” or “contains . . . a,” does not, without more constraints, preclude the existence of additional identical elements in the process, method, article, or arrangement that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or arrangement described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An imaging module for electro-optically imaging different types of targets, comprising:
first and second, energizable, illuminating light assemblies for illuminating the different types of targets;
an imaging assembly including a solid-state imager exposable during successive first type and second type frames, wherein the first type of frames interleave with the second type of frames;
a controller operative for exposing the imager during a first exposure time period, and for not exposing the imager during a first non-exposed time period, during one of the first type of frames, and for energizing the first illuminating light assembly to produce a first illumination light pulse during the first exposure time period to capture return light from a first type of target illuminated by the first illumination light pulse,
the controller being further operative for exposing the imager during a second exposure time period, and for not exposing the imager during a second non-exposed time period, during one of the second type of frames, and for energizing the second illuminating light assembly to produce a second illumination light pulse during the second exposure time period to capture return light from a second type of target illuminated by the second illumination light pulse,
the controller being further operative for energizing the second illuminating light assembly to produce another second illumination light pulse during the first non-exposed time period, and for energizing the first illuminating light assembly to produce another first illumination light pulse during the second non-exposed time period, to produce a plurality of the first and second illumination light pulses having a combined illumination light output power that is substantially the same for each frame and at an illumination rate that enables a human eye to perceive the first and second illumination light pulses as substantially continuous in illumination from frame to frame;
wherein the first illuminating light assembly includes a diffuser for diffusing and directing the first illumination light pulses to the first type of target on a reflective surface,
wherein the second illuminating light assembly directs the second illumination light pulses directly without diffusing to the second type of target on a matte surface; and
wherein the first and second illumination light pulses have different amplitudes.

2. (canceled)

3. (canceled)

4. (canceled)

5. The imaging module of claim 1, wherein the controller energizes at least one of the first and second illuminating light assemblies to produce at least one additional first and second illumination light pulse during the first non-exposed time period, and wherein the controller energizes at least one of the first and second illuminating light assemblies to produce at least one additional first and second illumination light pulse during the second non-exposed time period.

6. The imaging module of claim 1, wherein the first illuminating light assembly includes a plurality of light emitting diodes arranged around the imager.

7. The imaging module of claim 1, wherein the second illuminating light assembly includes at least one light emitting diode arranged adjacent the imager.

8. An arrangement for electro-optically reading different types of targets by image capture, comprising:
a housing having a light-transmissive window facing the different types of targets; and
an imaging module supported by the housing and including first and second, energizable, illuminating light assemblies for illuminating the different types of targets through the window;
an imaging assembly including a solid-state imager exposable during successive first type and second type frames, wherein the first type of frames interleave with the second type of frames;
a controller operative for exposing the imager during a first exposure time period, and for not exposing the imager during a first non-exposed time period, during one of the first type of frames, and for energizing the first illuminating light assembly to produce a first illumination light pulse during the first exposure time period to capture return light through the window from a first type of target illuminated by the first illumination light pulse,
the controller being further operative for exposing the imager during a second exposure time period, and for not exposing the imager during a second non-exposed time period, during one of the second type of frames, and for energizing the second illuminating light assembly to produce a second illumination light pulse during the second exposure time period to capture return light through the window from a second type of target illuminated by the second illumination light pulse,
the controller being further operative for energizing the second illuminating light assembly to produce another second illumination light pulse during the first non-exposed time period, and for energizing the first illuminating light assembly to produce another first illumination light pulse during the second non-exposed time period, to produce a plurality of the first and second illumination light pulses having a combined illumination light output power that is substantially the same for each frame and at an illumination rate that enables a human eye to perceive the first and second illumination light pulses as substantially continuous in illumination from frame to frame;
wherein the first illuminating light assembly includes a diffuser for diffusing and directing the first illumination light pulses to the first type of target on a reflective surface;
wherein the second illuminating light assembly directs the second illumination light pulses directly without diffusing to the second type of target on a matte surface; and
wherein the first and second illumination light pulses have different amplitudes.

9. (canceled)

10. (canceled)

11. (canceled)

12. The arrangement of claim 8, wherein the controller energizes at least one of the first and second illuminating light assemblies to produce at least one additional first and second illumination light pulse during the first non-exposed time period, and wherein the controller energizes at least one of the first and second illuminating light assemblies to produce at least one additional first and second illumination light pulse during the second non-exposed time period.

13. The arrangement of claim 8, wherein the first illuminating light assembly includes a plurality of light emitting diodes arranged around the imager.

14. The arrangement of claim 8, wherein the second illuminating light assembly includes at least one light emitting diode arranged adjacent the imager.

15. A method of electro-optically reading different types of targets by image capture, comprising:
illuminating the different types of targets with first and second, energizable, illuminating light assemblies;
operating a solid-state imager during successive first type and second type frames wherein the first type of frames interleave with the second type of frames;
exposing the imager during a first exposure time period, and not exposing the imager during a first non-exposed time period, during one of the first type of frames;
energizing the first illuminating light assembly to produce a first illumination light pulse during the first exposure time period to capture return light from a first type of target illuminated by the first illumination light pulse;
exposing the imager during a second exposure time period, and not exposing the imager during a second non-exposed time period, during one of the second type of frames;
energizing the second illuminating light assembly to produce a second illumination light pulse during the second exposure time period to capture return light from a second type of target illuminated by the second illumination light pulse;
energizing the second illuminating light assembly to produce another second illumination light pulse during the first non-exposed time period;
energizing the first illuminating light assembly to produce another first illumination light pulse during the second non-exposed time period, to produce a plurality of the first and second illumination light pulses having a combined illumination light output power that is substantially the same for each frame and at an illumination rate that enables a human eye to perceive the first and second illumination light pulses as substantially continuous in illumination from frame to frame;
diffusing and directing the first illumination light pulses to the first type of target on a reflective surface;
directing the second illumination light pulses directly without diffusing to the second type of target on a matte surface;
configuring the first and second illumination light pulses with different amplitudes.

16. (canceled)

17. (canceled)

18. (canceled)

19. The method of claim 15, and energizing at least one of the first and second illuminating light assemblies to produce at least one additional first and second illumination light pulse during the first non-exposed time period, and energizing at least one of the first and second illuminating light assemblies to produce at least one additional first and second illumination light pulse during the second non-exposed time period.

20. The method of claim 19, and configuring all of the illumination light pulses during the one frame to have substantially the same output light power as all of the illumination light pulses during the other frame.
